(19) United States
(12) Patent Application Publication
(10) Pub. No.: US 2012/0143513 A1
(43) Pub. Date: Jun. 7, 2012

(54) BIO-SENSOR CHIP AND READER THEREOF

(75) Inventors: Jong-Heon YANG, Daejeon (KR); Chang-Geun Ahn, Daejeon (KR); Chan Woo Park, Daejeon (KR); Chil Seong Ah, Daejeon (KR); Wan Joong Kim, Goyang (KR); Kwang Hyo Chung, Daejeon (KR); Yo Han Choi, Daejeon (KR); Gun Yong Sung, Daejeon (KR)

(73) Assignee: Electronics and Telecommunications Research, Daejeon (KR)

(21) Appl. No.: 13/219,197

(22) Filed: Aug. 26, 2011

(30) Foreign Application Priority Data
Dec. 3, 2010 (KR) 10-2010-0122868

(51) Int. Cl. G06F 19/10

(52) U.S. Cl. 702/19

(57) ABSTRACT

Provided are a bio sensor chip and a reader thereof. The bio-sensor chip is optically addressed. The bio-sensor chip includes a word line control circuit and a bit line control circuit controlled by light provided from the bio-sensor chip reader. The bio-sensor chip does not require a peripheral circuit for driving word lines and bit lines, simplifying a fabrication process and reducing the area of the chip.

### CROSS-REFERENCE TO RELATED APPLICATIONS

This U.S. non-provisional patent application claims priority under 35 U.S.C. §119 of Korean Patent Application No. 10-2010-0122868, filed on Dec. 3, 2010, the entire contents of which are hereby incorporated by reference.

### BACKGROUND OF THE INVENTION

The present invention disclosed herein relates to a bio-sensor chip and, more particularly, to an optically addressable bio-sensor chip and a reader thereof

Recently, research fields of science technologies are moving toward converging of technologies in various fields, as well as continuation of research into one independent field. For example, in order to better quality of life of human beings, research into a convergence technology by grafting high technologies such as biotechnology and nano-technology is actively ongoing.

Meanwhile, the demand for an improvement in quality of life and the entry into an aging society is changing a medical service paradigm from diagnosis and medical treatment of diseases to prevention and management of diseases. In line with this, demand for a ubiquitous healthcare allowing any one to be provided with a medical service in a desired place anytime and anywhere is also increasing. In the ubiquitous healthcare sector, a medical environment is changing from s clinic-oriented environment to a client-oriented, namely, patient-oriented environment. In particular, a bio-sensor chip, one of the essentials for implementing a ubiquitous healthcare, is a semiconductor chip developed by grafting the biotechnology and nano-technology.

A bio-sensor constituting the bio-sensor chip is variably defined. In general, a bio-sensor refers to the combination of a biological acceptor having a recognition function with respect to a particular material and an electrical or optical converter. The bio-sensor is an element for sensing a particular material through an interaction, a recognition reaction or a chemical reaction between the particular material and a biological acceptor and converting the same into an electrical or optical signal. A bio-sensor chip including the bio-sensor, having simplicity, rapidity and sensitivity in a measurement and portability of the chip, allows for diagnosing, checking, or the like, in an area in which there is no laboratory, experiment equipment, or the like. Also, the bio-sensor chip is utilized in various fields such as food, environment, national defense, and the like.

Another technology related to the present invention is a bio-complementary metal-oxide semiconductor (CMOS) field. Bio-CMOS refers to a system capable of quickly analyzing and detecting various phenomena related to bio with a small amount of sample by using CMOS large-scale integrated circuit (LSI). The bio-CMOS field is expected to come to prominence in the market of DNA chips or diagnostic bio-sensors largely employing an optical detection scheme.

A typical addressing scheme used in an electronic element having an array structure is a technique used in a high-performance semiconductor chip such as a memory device, a central processing unit (CPU), or the like. However, currently developed electronic elements are expected to perform various functions with various materials, an addressing technique different from the typical one may be advantageous. For example, in case of a bio-CMOS technology, the electronic elements are mostly onetime used in terms of the application field, so it is important to reduce a fabrication cost, rather than a chip speed or performance. However, the use of the electrical addressing scheme for the bio-CMOS leads to an increase in the area of a chip and an increase in the process cost because of the necessity of a peripheral circuit, and the like, which, thus, needs to be improved.

### SUMMARY OF THE INVENTION

The present invention provides an optically addressable bio-sensor chip and a reader thereof.

Embodiments of the present invention provide bio-sensor chips including: unit cells connected to a plurality of word lines and a plurality of bit lines and including bio-sensors, respectively; a word line control circuit selecting any one of the word lines; and a bit line control circuit selecting any one of the bit lines, wherein the word line control circuit and the bit line control circuit are controlled by light.

In some embodiments, the word line control circuit may include a plurality of photo switches connected to the word lines, respectively.

In other embodiments, the photo switches may deliver a word line voltage to the word lines, respectively, when the light is irradiated thereto.

In still other embodiments, each of the photo switches may include a photoresponse element controlled by light and a switching transistor controlled by the photoresponse element.

In even other embodiments, the bit line control circuit may include a plurality of photo switches connected to the bit lines, respectively.

In yet other embodiments, the photo switches may deliver a bit line voltage to the bit lines, respectively, when the light is irradiated thereto.

In further embodiments, each of the photo switches may include a photoresponse element controlled by light.

In still further embodiments, each of the photo switches may include a switching transistor controlled by the photoresponse element.

In even further embodiments, the bio-sensor chips may include: an input terminal for receiving a word line voltage provided to the word lines.

In yet further embodiments, the bio-sensor chips may include: an input terminal for receiving a bit line voltage provided to the bit lines.

In much further embodiments, the bio-sensor is an element for detecting a particular material by a biological acceptor through an interaction, a recognition reaction, an oxidation-reduction reaction, or a chemical reaction, and outputting the detection results as an electrical signal.

In other embodiments of the present invention, bio-sensor chip readers for receiving a bio-sensor chip thereon, driving the bio-sensor chip, and analyzing an output from the bio-sensor chip, include: a word line light source unit outputting light for selecting a word line of the bio-sensor chip; a bit line light source unit outputting light for selecting a bit line of the bio-sensor chip; an analog-to-digital converter (ADC) converting an output signal from the bio-sensor chip into a digital signal; and a controller controlling the word line light source unit and the bit light source unit to drive the bio-sensor chip, and analyzing the output from the bio-sensor chip provided through the ADC.

In some embodiments, the bio-sensor chip may include: unit cells connected to a plurality of word lines and a plurality of bit lines and including bio-sensors, respectively; a word line control circuit selecting any one of the word lines; and a bit line control circuit selecting any one of the bit lines, wherein one of the unit cells may be selected by the word line control circuit controlled by the light output from the word line light source unit and the bit line control circuit controlled by the light output from the bit line light source unit.

In other embodiments, the bio-sensor chip readers may include an output terminal for outputting a word line voltage to be provided to the word line.

In still other embodiments, the bio-sensor chip readers may include an output terminal for outputting a bit line voltage to be provided to the bit line.

In even other embodiments, the bio-sensor chip readers may include an input terminal for receiving an output signal from the bio-sensor chip.

In yet other embodiments, the bio-sensor chip readers may further include: a cell light source unit outputting light to be irradiated to the unit cells of the bio-sensor chip.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a conceptual view showing an addressing method of a bio-sensor chip according to an exemplary embodiment of the present invention;

FIG. 2 is a circuit diagram of an address control circuit of a bio-sensor chip according to a first exemplary embodiment of the present invention;

FIG. 3 is a circuit diagram of an address control circuit of a bio-sensor chip according to a second exemplary embodiment of the present invention;

FIG. 4 is an equivalent circuit diagram of a unit cell constituting the bio-sensor chip according to an exemplary embodiment of the present invention;

FIG. 5 is a view for explaining the structure and an operational principle of the unit cell illustrated in FIG. 4;

FIG. 6 is an equivalent circuit diagram of a different unit cell constituting the bio-sensor chip according to an exemplary embodiment of the present invention;

FIG. 7 is a view for explaining the structure and an operational principle of the unit cell illustrated in FIG. 6;

FIG. 8 is a conceptual view of a bio-sensor chip and a reader thereof according to a third exemplary embodiment of the present invention;

FIG. 9 is a conceptual view of a bio-sensor chip and a reader thereof according to a fourth exemplary embodiment of the present invention; and

FIG. 10 is a schematic block diagram of a bio-sensor chip reader according to the third and fourth exemplary embodiments of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the drawings, the dimensions of layers and regions are exaggerated for clarity of illustration. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Hereinafter, it will be described about an exemplary embodiment of the present invention in conjunction with the accompanying drawings.

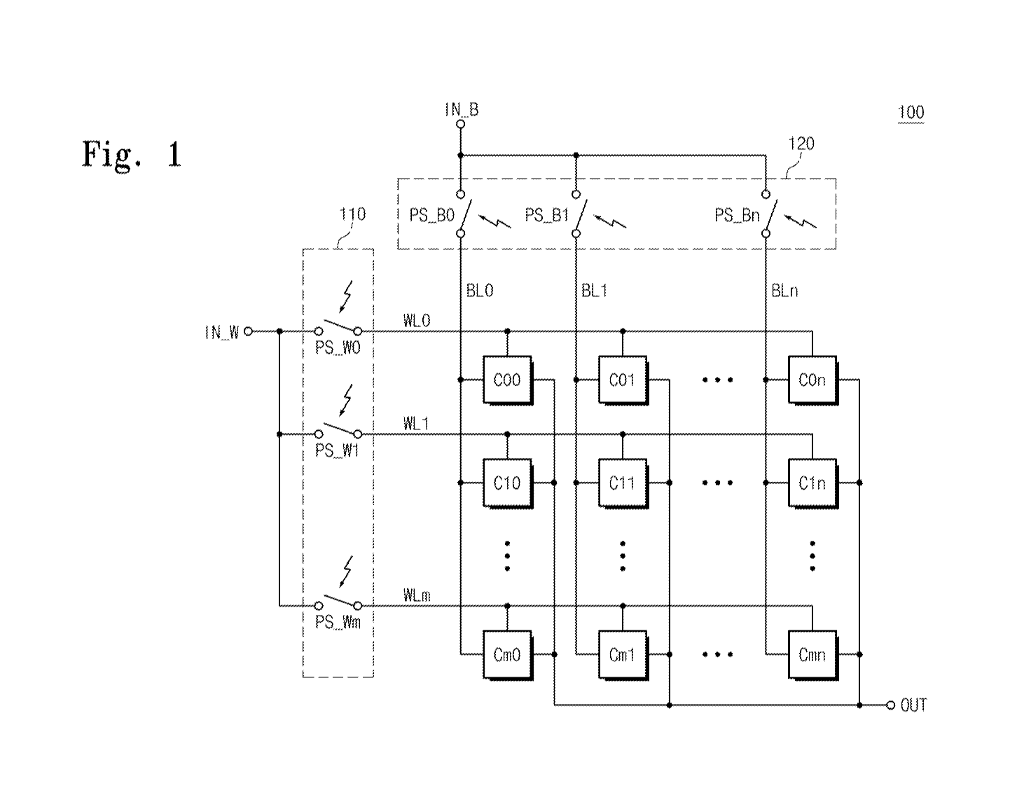

FIG. 1 is a conceptual view showing an addressing method of a bio-sensor chip according to an exemplary embodiment of the present invention.

A bio-sensor chip 100 according to an exemplary embodiment of the present invention is optically addressed. Namely, in the bio-sensor chip 100, one of word lines WL0 to WLm and one of bit lines BL0 to BLN are selected through word line control circuits 110 and bit line control circuits 120 controlled by external light. Since a peripheral circuit for driving the word lines and bit lines is not used in the bio-sensor chip 100 according to the present exemplary embodiment, a fabrication process can be simplified and the area of chip can be reduced.

With reference to FIG. 1, the bio-sensor chip 100 includes the plurality of word line control circuits 110, the plurality of bit lines control circuits 120, and a plurality of bio sensors C00 to Cmn. The bio-sensors C00 to Cmn are formed at areas defined as the word lines WL0 to WLm and the bit lines BL0 and BLn cross each other. The bio-sensors C00 to Cmn may be sensors for sensing the same material or may be sensors for sensing different materials, respectively.

In the following description, each of the bio-sensors C00 to Cmn will be referred to as a unit cell. The unit cell is defined as a combination of a biological acceptor having a recognition function with respect to a particular material and an electrical or optical converter. Namely, the unit cell is an element for sensing a particular material through an interaction, a recognition reaction, an oxidation-reduction reaction, or a chemical reaction between a particular material and a biological acceptor and converting the sensed material into an electrical or optical signal. Here, the particular material includes general chemical materials, as well as bio-materials such as DNA, protein, and the like. The biological acceptor is a bio-molecule serving to generate a signal measurable by a converter immediately when the particular material is recognized. The biological acceptor includes enzyme, protein, DNA, cells, hormone, membrane, and the like.

The word line control circuits 110 include photo switches PS_WO to PS_W m connected to the word lines WL0 to WLm, respectively. The bit line control circuits 120 include photo switches PS_B0 to PS_Bn connected to the bit lines BL0 to BLn, respectively. The word lines control circuits 110 and the bit line control circuits 120 are photoresponse elements controlled by light, respectively. The photoresponse element may include a photo diode, a solar cell, a photo transistor, or the like.

When light is irradiated, the word line control circuits 110 deliver a signal input through the input terminal IN_W to the word lines connected thereto, respectively. Namely, the word line control circuits 110 may select a word line according to light. The bit line control circuits 120 also perform the same function as that of the word line control circuits 110. Namely, the bit line control circuits 120 may select a bit line according to light.

According to the present exemplary embodiment, a particular word line is selected by a word line control circuit to which light irradiated, and a particular bit line is selected by a bit line control circuit to which light is irradiated. Namely, in the bio-sensor chip 100, an address is optically controlled to access a particular unit cell. Only a unit cell connected to the selected word line and the selected bit line is driven. The selected unit cell may output a signal to the exterior of the bio-sensor chip 100 through an output terminal OUT.

The bio-sensor chip 100 according to the present exemplary embodiment does not require peripheral circuits (e.g., a low decoder, a column decoder, a word line driver, a bit line driver, etc.) for driving the word lines and the bit lines, and thus the fabrication process can be simplified and the area of the chip can be reduced. Also, input terminals IN_W and IN_B for inputting signals to be provided to the word lines and the bit lines and an output terminal for outputting a signal output from a selected unit cell can be commonly grouped. Thus, the input/output terminals of the bio-sensor chip 100 can be simplified, and a packaging process of the bio-sensor chip 100 can be accordingly simplified.

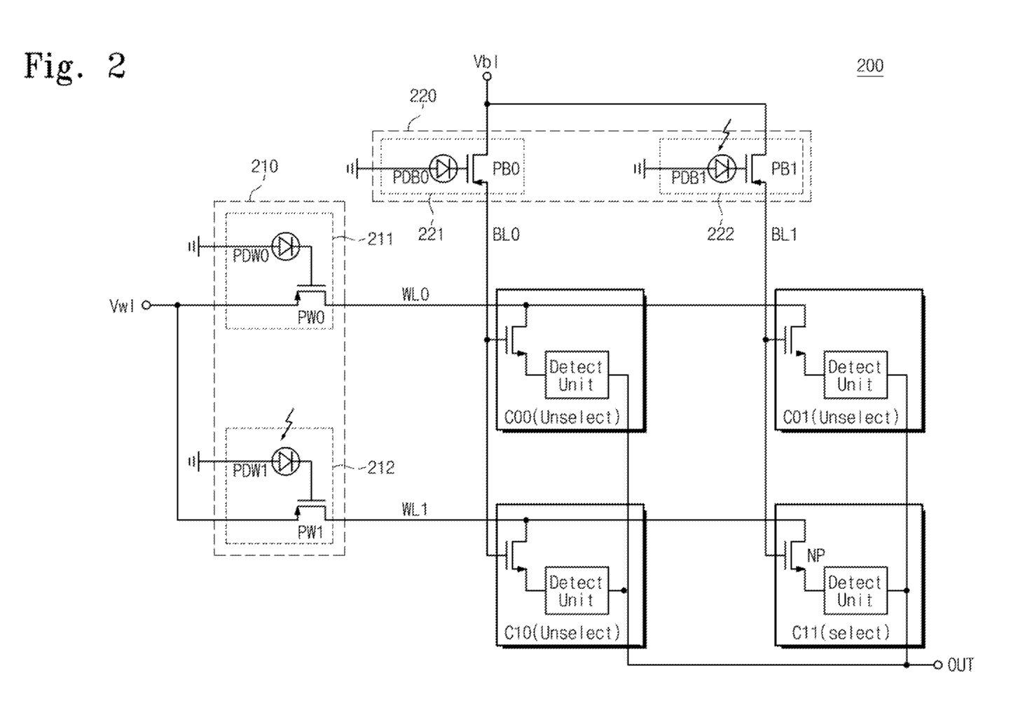

FIG. 2 is a circuit diagram of an address control circuit of a bio-sensor chip according to a first exemplary embodiment of the present invention. In FIG. 2, it is assumed that a bio-sensor chip 200 includes four unit cells, for the sake of brevity.

With reference to FIG. 2, the bio-sensor chip 200 according to the first exemplary embodiment of the present invention includes a plurality of word lines control circuits 210, a plurality of bit line control circuits 220, and a plurality of unit cells C00 to C11.

The word line control circuits 210 include photo switches 211 and 212 connected to the word lines WL0 and WL1, respectively. The bit line control circuits 220 include photo switches 221 and 222 connected to the bit lines BL0 and BL1, respectively. Each of the photo switches 211, 212, 221 and 222 includes one photoresponse element and one switching transistor. Each of the switching transistors of the photo switches is controlled by an output from each of photo diodes. In the first exemplary embodiment of the present invention, the photoresponse elements are assumed to be the photo diodes.

Each of the unit cells C00 to C11 includes one pass transistor and one detect unit. The pass transistor of each of the unit cells C00 to C11, controlled by the voltage provided through bit lines, delivers the voltage provided through the word lines to the detect unit.

When light is irradiated, the photo switches 211 and 212 deliver a voltage Vw1 input through an input terminal to the word lines connected thereto, respectively. When light is irradiated, the photo switches 221 and 222 deliver a voltage Vb1 input through an input terminal to the bit lines connected thereto, respectively. Here, the word lines to which the voltage has been delivered are selected word lines, and the bit lines to which the voltage has been delivered are selected bit lines. Only the unit cells connected to the selected word lines and the selected bit lines are driven as selected unit cells.

To help understand the present invention, a method for selecting the unit cell C11 will now be described.

When light is irradiated, the photo diode PDW1 of the photo switch 212 generates an electron-hole pair, and accordingly, it outputs a negative voltage to the gate of the switching transistor PW1. The switching transistor PW1 configured as a PMOS transistor is controlled according to the negative voltage applied to the gate so as to be turned on. When the switching transistor PW1 is turned on, it delivers the word line voltage Vw1 to the word line WL1. Accordingly, the word line WL1 is selected.

When light is irradiated, the photo diode PDB1 of the photo switch 222 generates an electron-hole pair, and accordingly, it outputs a negative voltage to the gate of the switching transistor PB1. The switching transistor PB1 configured as a PMOS transistor is controlled according to the negative voltage applied to the gate so as to be turned on. When the switching transistor PB1 is turned on, it delivers the bit line voltage Vb1 to the bit line BL1. Accordingly, the bit line BL1 is selected.

A pass transistor NP of the unit cell C11 configured as an NMOS transistor is controlled according to the bit line voltage Vb1 delivered through the bit line BL1 so as to be turned on. When turned on, the pass transistor NP delivers the word lines voltage Vw1 which has been delivered through the word line WL1 to a detect unit of the unit cell C11. Accordingly, the unit cell C11 is driven, and an output signal of the unit cell C11 is output to the exterior through an output terminal OUT.

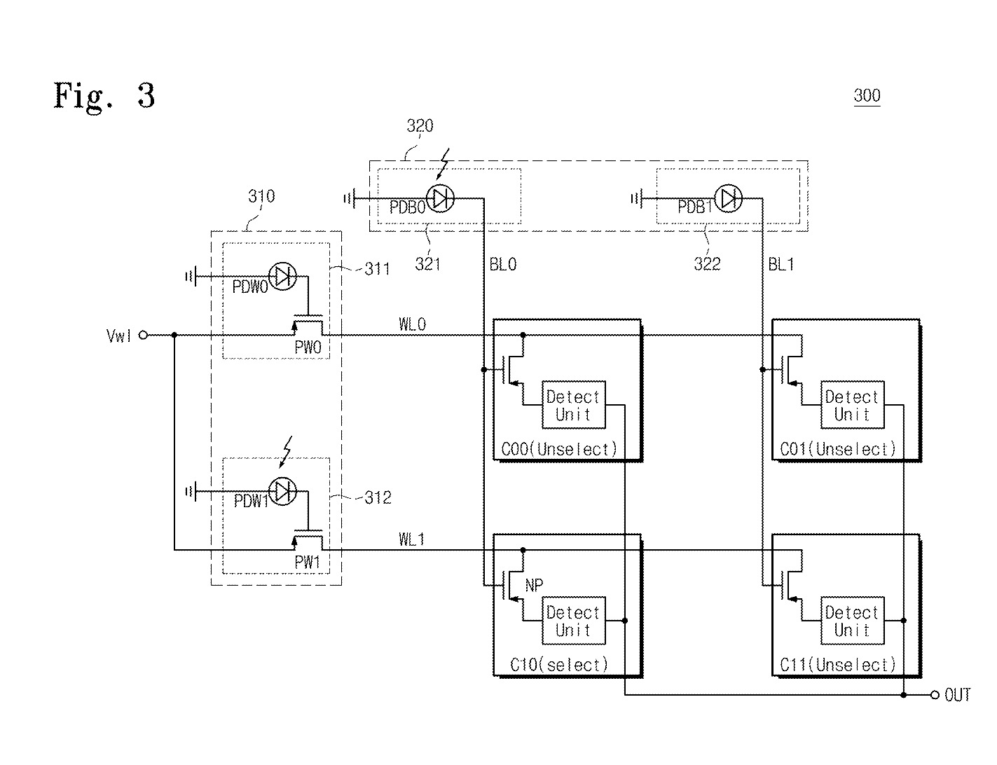

FIG. 3 is a circuit diagram of an address control circuit of a bio-sensor chip according to a second exemplary embodiment of the present invention. In FIG. 3, it is assumed that a bio-sensor chip 300 includes four unit cells, for the sake of brevity.

With reference to FIG. 3. the bio-sensor chip 300 according to the second exemplary embodiment of the present invention includes a plurality of word lines control circuits 310, a plurality of bit line control circuits 320, and a plurality of unit cells C00 to C11.

The word line control circuits 310 include photo switches 311 and 312 connected to the word lines WL0 and WL1, respectively. Each of the photo switches 311 and 312 includes one photoresponse element and one switching transistor. Each of the switching transistors of the photo switches 311 and 312 is controlled by an output from each of photo diodes. In the second exemplary embodiment of the present invention, the photoresponse elements are assumed to be the photo diodes.

The bit line control circuits 320 include photo switches 321 and 322 connected to the bit lines BL0 and BL1, respectively. Each of the photo switches 321 and 322 includes one photoresponse element. In the second exemplary embodiment of the present invention, the photoresponse elements are assumed to be photo diodes.

Each of the unit cells C00 to C11 includes one pass transistor and one detect unit. The pass transistor of each of the unit cells C00 to C11, controlled by the voltage provided through bit lines, delivers the voltage provided through the word lines to the detect unit.

When light is irradiated, the photo switches 311 and 312 deliver a voltage Vw1 input through an input terminal to the word lines connected thereto, respectively. When light is irradiated, the photo switches 321 and 322 generate an electron-hole pair and accordingly output a negative voltage. Thus, when light is irradiated, the photo switches 321 and 322 provide the negative voltage to the bit lines connected thereto. Here, the word lines to which the voltage has been delivered are selected word lines, and the bit lines to which the voltage has been delivered are selected bit lines. Only the unit cells connected to the selected word lines and the selected bit lines are driven as selected unit cells.

To help understand the present invention, a method for selecting the unit cell C10 will now be described.

When light is irradiated, the photo diode PDW1 of the photo switch 312 generates an electron-hole pair, and accordingly, it outputs a negative voltage to the gate of the switching transistor PW1. The switching transistor PW1 configured as a PMOS transistor is controlled according to the negative voltage applied to the gate so as to be turned on. When the switching transistor PW1 is turned on, it delivers the word line voltage Vw1 to the word line WL1. Accordingly, the word line WL1 is selected.

When light is irradiated, the photo diode PDB0 of the photo switch 321 generates an electron-hole pair, and accordingly, it outputs a negative voltage the bit line BL0. Accordingly, the bit line BL0 is selected.

A pass transistor NP of the unit cell C10 configured as a PMOS transistor is controlled according to the bit line voltage (i.e., the negative voltage) delivered through the bit line BL0 so as to be turned on. When turned on, the pass transistor NP delivers the word lines voltage Vw1 which has been delivered through the word line WL1 to a detect unit of the unit cell C10. Accordingly, the unit cell C10 is driven, and an output signal from the unit cell C10 is output to the exterior through an output terminal OUT.

The word line control circuits and the bit line control circuits controlled by light have been described with reference to FIGS. 2 and 3. However, the word line control circuits and the bit line control circuits are not meant to be limited thereto. For example, the word line control circuits and the bit line control circuits may be configured as various circuits which may be controlled by light to select word lines and bit lines.

FIG. 4 is an equivalent circuit diagram of a unit cell constituting the bio-sensor chip according to an exemplary embodiment of the present invention. With reference to FIG. 4, a unit cell 400 includes a pass transistor PTR and a detect unit.

The gate of the pass transistor PTR of the unit cell 400 is connected to a bit line and a source thereof is connected to a word line. The pass transistor PTR of the unit cell 400 is controlled by a voltage provided through the bit line to deliver a voltage provided through the word line to the detect unit.

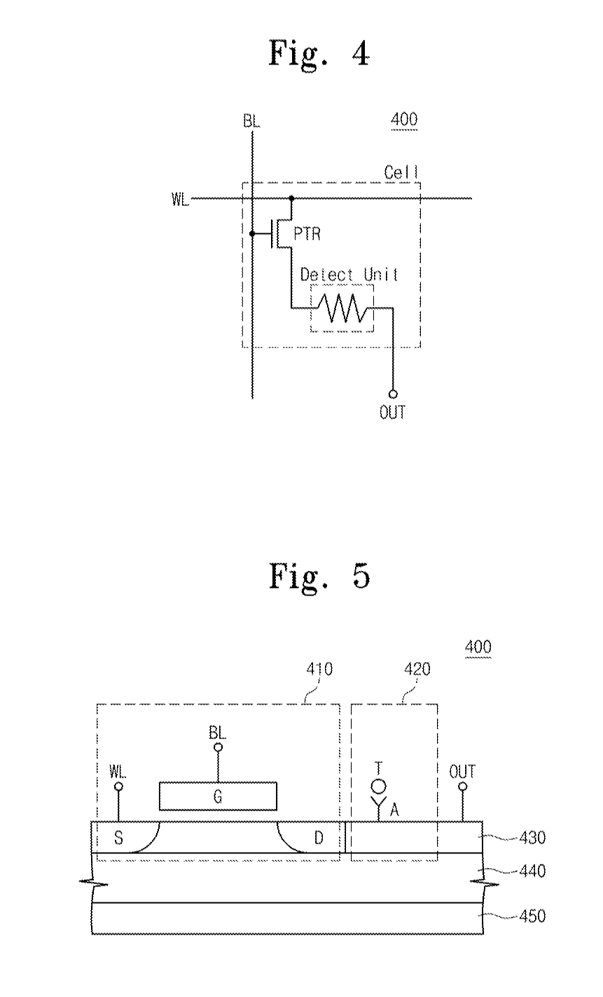

The detect unit is formed by configuring a silicon nanowire as a channel and fixing a biological acceptor, i.e., a bio-material, on a surface of the silicon nanowire. In general, the detect unit operates based on a principle that a detection material, reacting to the bio-material, is interacted, recognition-reacted, oxidation-reduction reacted, or chemically reacted on the silicon nanowire to change electrical characteristics of the detect unit. In FIG. 4, the detect unit is illustrated as a resistor as an equivalent circuit. Namely, the detect unit illustrated in FIG. 4 operates based on the principle that a detection material, reacting to a bio-material, changes electrical conductivity of the silicon nanowire. The structure and operational principle of the detect unit will be described in detail with reference to FIG. 5.

FIG. 5 is a view for explaining the structure and an operational principle of the unit cell illustrated in FIG. 4. With reference to FIG. 5, a unit cell 400 includes a pass transistor 410 formed on a semiconductor substrate 450 and a detect unit 420 including a silicon nanowire 430 having a linear shape and formed on the semiconductor substrate 450. The detect unit 420 is connected to the drain (D) and insulated with the semiconductor substrate 450 by an insulating layer 440.

An acceptor (A), namely, a bio-material, is fixed on the surface of the silicon nanowire 430. In FIG. 5, one bio-material (A) is illustrated, but it could be easily understood that a plurality of bio-materials can be fixed to the surface of the silicon nanowire 430.

In order to explain the operational principle of the unit cell 400, the following is assumed. Also, it is assumed that the silicon nanowire 430 is N type silicon, for the sake brevity. A target (T), namely, the detection material, assumes a positive charge (+) or a negative charge (−) according to a detection method and environment, and here, it is assumed that the detection material assumes a negative charge (−), for the sake of brevity.

When no reaction occurs between the acceptor (A) and the target (T) on the surface of the silicon nanowire 430, electric conductivity of the silicon nanowire 430 is uniformly maintained. Meanwhile, when the acceptor (A) and the target (T) are reacted to each other, the target (T) assuming the negative voltage (−) exists on the surface of the silicon nanowire 430. Thus, charge depletion occurs in the silicon nanowire 430, reducing electron concentration. Accordingly, electric conductivity is reduced. Namely, electric conductivity of the silicon nanowire 430 has correlation according to the density of the acceptor (A)—target (T) reacting on the surface, and the density of the quantitative target (T) can be measured by using the correlation.

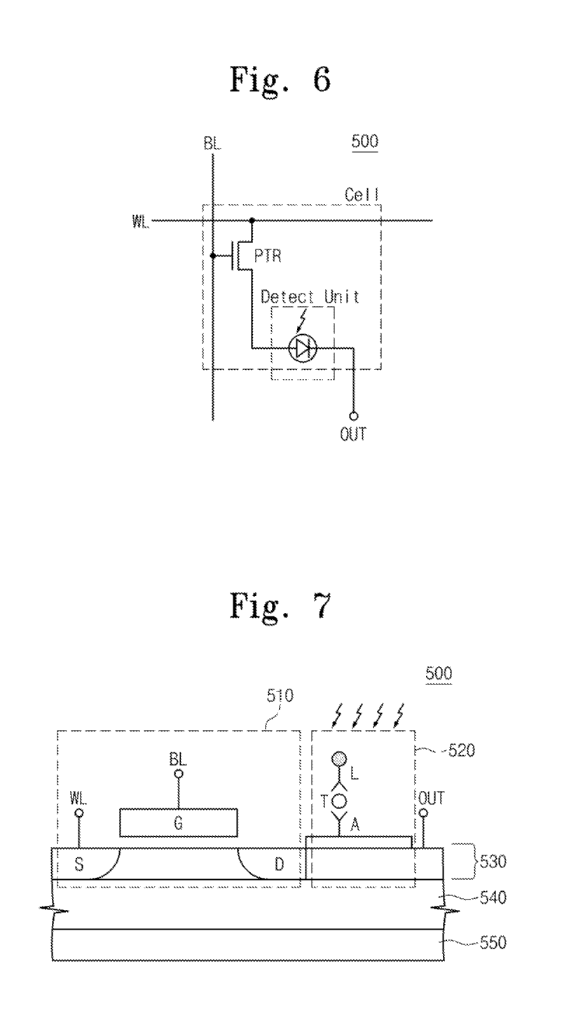

FIG. 6 is an equivalent circuit diagram of a different unit cell constituting the bio-sensor chip according to an exemplary embodiment of the present invention. With reference to FIG. 6, a unit cell 500 includes a pass transistor PTR and a detect unit.

The gate of the pass transistor PTR of the unit cell 500 is connected to a bit line, and the source thereof is connected to a word line. The pass transistor PTR of the unit cell 500 is controlled by a voltage provided through the bit line to deliver a voltage provided through the word line to the detect unit.

The detect unit is formed by configuring a photo detector and fixing a biological acceptor, i.e., a bio-material, on a surface of the photo detector. In general, the detect unit operates based on a principle that a detection material, reacting to the bio-material, is interacted, recognition-reacted, oxidation-reduction reacted, or chemically reacted to the silicon nanowire to change electrical characteristics of the detect unit. In FIG. 6, the detect unit is illustrated as the photo detector as an equivalent circuit. Namely, the detect unit illustrated in FIG. 6 operates based on the principle that a detection material, reacting to a bio-material, changes a current generation of the detect unit. The structure and operational principle of the detect unit will be described in detail with reference to FIG. 7.

FIG. 7 is a view for explaining the structure and an operational principle of the unit cell illustrated in FIG. 6. With reference to FIG. 7, a unit cell 500 includes a pass transistor 510 formed on a semiconductor substrate 550 and a detect unit 520 including a photo detector 530 generating current by light. The detect unit 520 is connected to the drain (D) and insulated with the semiconductor substrate 550 by an insulating layer 540.

An acceptor (A), namely, a bio-material, is fixed on the surface of the photo detector 530. In FIG. 7, one bio-material (A) is illustrated, but it could be easily understood that a plurality of bio-materials can be fixed to the surface of the photo detector 530.

When no reaction occurs between the acceptor (A) and the target (T) on the surface of the photo detector 530, the amount of current generated from the photo detector 530 by light can be uniformly maintained. Meanwhile, when the acceptor (A) and the target (T) are reacted, a secondary antibody (L) coupled with a nano particle mark or a fluorescent material mark is attached to the target (T). Accordingly, the amount of light irradiated to the photo detector 530 is reduced to reduce the amount of current generated from the photo detector 530. When the nano particle mark is used, a gold (Au) or silver (Ag) thin film may be additionally grown from the nano particle to reduce the amount of light to amplify a detect signal.

The unit cells included in the bio-sensor chips have been exemplified with reference to FIGS. 4 to 7. However, it could be well understood that the unit cells are not limited to the foregoing structures. For example, the unit cells may be formed to have various structures according to a material desired to be detected.

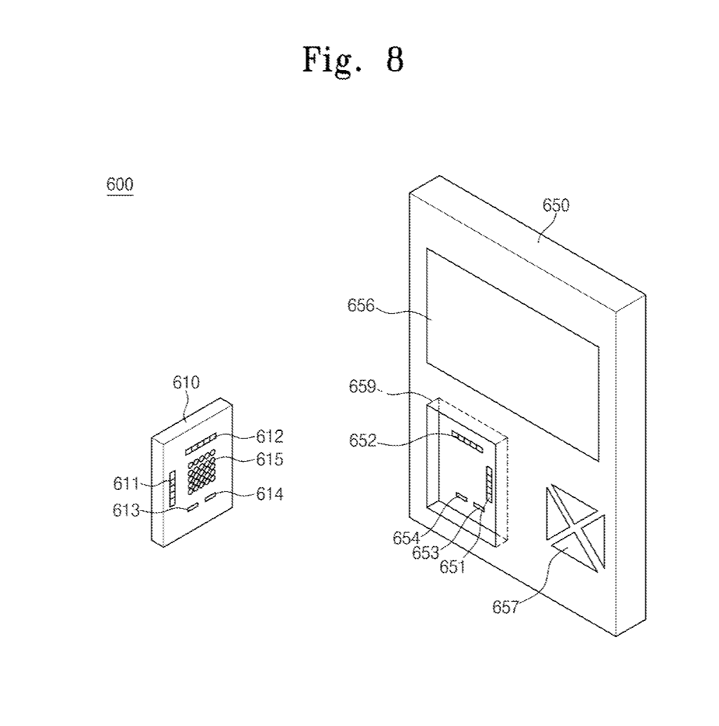

FIG. 8 is a conceptual view of a bio-sensor chip and a reader thereof according to a third exemplary embodiment of the present invention.

A bio-sensor chip reader 650, allowing a bio-sensor chip 610 to be mounted thereon, is a medical information terminal to drive the bio-sensor chip 610 to detect and analyze an output signal from the bio-sensor chip 610. The bio-sensor chip 610 has a package form so as to be easily moved and kept in storage.

A mount recess 659 is formed on one surface of the bio-sensor chip reader 650 in order to allow the bio-sensor chip 610 to be mounted therein. A display unit 656 for displaying the results obtained by detecting and analyzing the output signal from the bio-sensor chip 610 and an input unit 657 for receiving a user control signal are disposed.

The bio-sensor chip 610 according to the present exemplary embodiment is optically addressed. Namely, in the bio-sensor chip 610, a word line and a bit line are selected by external light, and as a result, a unit cell is selected. In order to drive the bio-sensor chip 610 according to the present exemplary embodiment, units for driving the bio-sensor chip 610 are disposed on the bottom of the mounting recess 659 of the bio-sensor chip reader 650.

For example, a word line light emission unit 651 for irradiating light for selecting a word line and a bit line light emission unit 652 for irradiating light for selecting a bit line are disposed on the bottom of the mounting recess 659 of the bio-sensor chip reader 650. In addition, an output terminal 653 for providing a signal (e.g., a bias voltage to be provided to a word line and a bit line) to the bio-sensor chip 610 and an input terminal 654 for receiving a signal output from the bio-sensor chip 610 are disposed on the bottom of the mounting recess 659 of the bio-sensor chip reader 650.

Meanwhile, a word line light receiving unit 611 for receiving light irradiated from the word line light emission unit 651 and a bit line light receiving unit 612 for receiving light irradiated from the bit line light emission unit 652 are disposed on one surface of the bio-sensor chip 610 facing the bottom of the mounting recess 659. In addition, an input terminal 613 for receiving a signal (e.g., a bias voltage to be provided to a word line and a bit line) output from the output terminal 653 of the bio-sensor chip reader 650 and an output terminal 614 for providing a signal (e.g., an output signal from a unit cell) to the bio-sensor chip reader 650 are disposed on one surface of the bio-sensor chip 610 facing the bottom of the mounting recess 659. Also, a recess 615, to which a detection material is to be injected, may be disposed on one surface of the bio-sensor chip 610 facing the bottom of the mounting recess 659.

The bio-sensor chip reader 650 according to the third exemplary embodiment of the present invention can drive the bio-sensor chip 610 by using light and detect or analyze an output signal from the bio-sensor chip 610. Thus, an on-the-spot measurement can be possibly performed by a layman by using the bio-sensor chip reader 650, without the necessity of a laboratory, high-priced analyzing equipment, skilled analysis personnel, or the like.

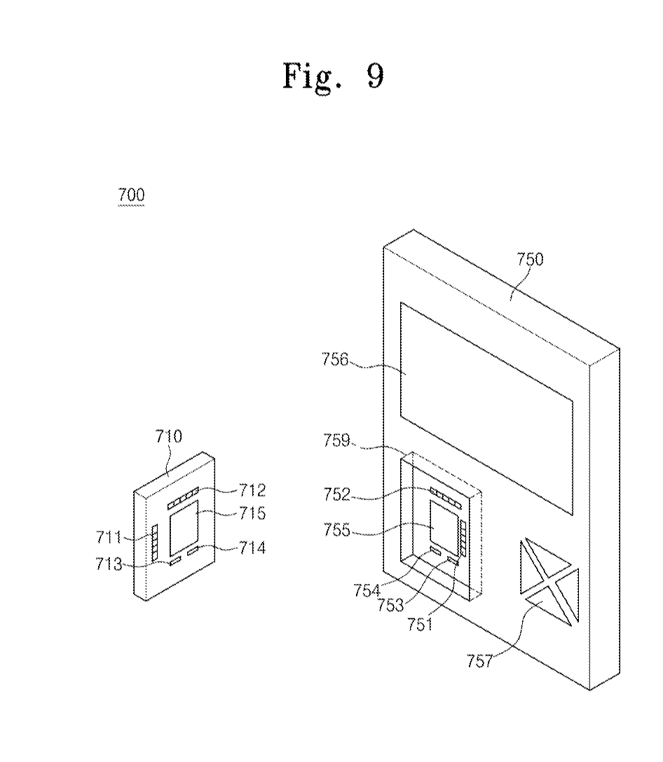

FIG. 9 is a conceptual view of a bio-sensor chip and a reader thereof according to a fourth exemplary embodiment of the present invention.

A bio-sensor chip reader 750, allowing a bio-sensor chip 710 to be mounted thereon, is a medical information terminal to drive the bio-sensor chip 710 to detect and analyze an output signal from the bio-sensor chip 710. The bio-sensor chip 710 has a package form so as to be easily moved and kept in storage.

A mount recess 759 is formed on one surface of the bio-sensor chip reader 750 in order to allow the bio-sensor chip 710 to be mounted therein. A display unit 756 for displaying the results obtained by detecting and analyzing the output signal from the bio-sensor chip 710 and an input unit 757 for receiving a user control signal are disposed.

The bio-sensor chip 710 according to the present exemplary embodiment is optically addressed. Namely, in the bio-sensor chip 710, a word line and a bit line are selected by external light, and as a result, a unit cell is selected. In order to drive the bio-sensor chip 710 according to the present exemplary embodiment, units for driving the bio-sensor chip 710 are disposed on the bottom of the mounting recess 759 of the bio-sensor chip reader 750.

For example, a word line light emission unit 751 for irradiating light for selecting a word line and a bit line light emission unit 752 for irradiating light for selecting a bit line are disposed on the bottom of the mounting recess 759 of the bio-sensor chip reader 750. In addition, an output terminal 753 for providing a signal (e.g., a bias voltage to be provided to a word line and a bit line) to the bio-sensor chip 710 and an input terminal 754 for receiving a signal output from the bio-sensor chip 710 are disposed on the bottom of the mounting recess 759 of the bio-sensor chip reader 750. Also, a cell light emitting unit 755 for irradiating light to a unit cell (not shown) of the bio-sensor chip 710 is disposed on the bottom of the mounting recess 759 of the bio-sensor chip reader 750.

Meanwhile, a word line light receiving unit 711 for receiving light irradiated from the word line light emission unit 751 and a bit line light receiving unit 712 for receiving light irradiated from the bit line light emission unit 752 are disposed on one surface of the bio-sensor chip 710 facing the bottom of the mounting recess 759. In addition, an input terminal 713 for receiving a signal (e.g., a bias voltage to be provided to a word line and a bit line) output from the output terminal 753 of the bio-sensor chip reader 750 and an output terminal 714 for providing a signal (e.g., an output signal from a unit cell) to the bio-sensor chip reader 750 are disposed on one surface of the bio-sensor chip 710 facing the bottom of the mounting recess 759. Also, a cell light receiving unit 715 for receiving light irradiated from the cell light emitting unit 755 may be disposed on one surface of the bio-sensor chip 710 facing the bottom of the mounting recess 759.

The bio-sensor chip reader 750 according to the fourth exemplary embodiment of the present invention can drive the bio-sensor chip 710 by using light and detect or analyze an output signal from the bio-sensor chip 710. Thus, an on-the-spot measurement can be possibly performed by a layman by using the bio-sensor chip reader 750, without the necessity of a laboratory, high-priced analyzing equipment, skilled analysis personnel, or the like.

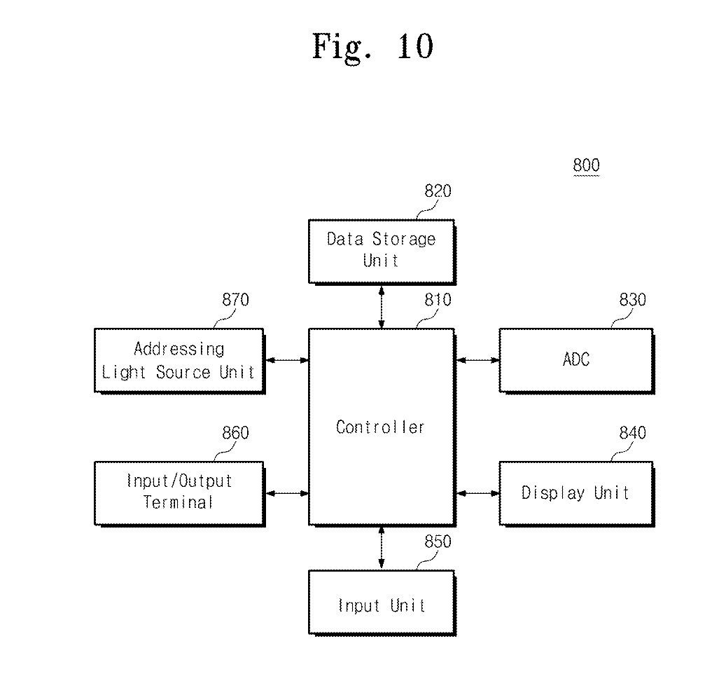

FIG. 10 is a schematic block diagram of a bio-sensor chip reader according to the third and fourth exemplary embodiments of the present invention. With reference to FIG. 10, a bio-sensor chip reader 800 includes a controller 810, a data storage unit 820, an analog-to-digital converter (ADC) 830, a display unit 840, an input unit 850, an input/output terminal 860, and an addressing light source unit 870.

The controller 810 controls a general operation of the bio-sensor chip reader 800. For example, when power is supplied, the controller 810 controls a booting process of a mobile communication terminal Also, the controller 810 activates or initializes each element of the bio-sensor chip reader 800 according to a user setting input through the input unit 850. The controller 810 may be configured to drive firmware for controlling the bio-sensor chip reader 800. Here, the firmware may be an analysis application program for driving a bio-sensor chip and analyzing an output from the bio-sensor chip. Such firmware is loaded to an operation memory of the data storage unit 820 so as to be driven.

The data storage unit 820 may include a volatile memory device such as a DRAM and a non-volatile memory device such as a ROM, a flash memory device, or the like. The data storage unit 820 may store data required for driving the bio-sensor chip reader 800. For example, the data storage unit 820 stores an operating system for driving the bio-sensor chip reader 800, an application program, and meta data required for driving a program.

The ADC 830 converts an output signal from the bio-sensor chip input through the input/output terminal 860 into a digital signal. The ADC 830 provides the converted signal to the controller 810.

The display unit 840 displays various messages, image information, or the like, under the control of the controller 810. When the display unit 840 is configured as a touch screen, the input unit 850 may be included in the display unit 840.

The controller 810 outputs a signal (e.g., a bias voltage) required for driving the bio-sensor chip through the input/output terminal 860. Also, the controller 810 outputs an address signal required for driving the bio-sensor chip through the addressing light source unit 870. Namely, the controller 810 controls the addressing light source unit 870 to select a word line and a bit line of the bio-sensor chip. The controller 810 detects or analyzes an output signal from the bi-sensor chip which has been converted by the ADC 830. The results obtained by detecting or analyzing the converted output signal by the controller 810 are displayed through the display unit 840.

Although not shown, the bio-sensor chip reader 800 may further include a wireless unit and a voice processing unit. The wireless unit may transmit or receive a voice signal or data under the control of the controller 810. To this end, the wireless unit may include a radio frequency (RF) transceiver. Also, the wireless unit may include a WLAN module. The voice processing unit may reproduce voice data received through the wireless unit. Also, the voice processing unit may collect a user's voice or other voice signals.

When the bio-sensor chip reader 800 further includes the wireless unit and the voice processing unit, the bio-sensor chip reader 800 may operate as a mobile communication terminal, as well as operate as a reader for driving the bio-sensor chip and analyze an output signal from the bio-sensor chip. Namely, the bio-sensor chip reader 800 may have both the function of a mobile communication terminal and the function of a bio-sensor chip reader. For example, the bio-sensor chip reader 800 may transmit and receive a voice signal or data through the wireless unit and the voice processing unit in a call mode. Also, the bio-sensor chip reader 800 may drive the bio-sensor chip and drive an application program for analyzing an output from the bio-sensor chip in an analysis mode.

The bio-sensor chip reader 800 may transmit analysis results to a remote medical treatment system through the wireless unit in the analysis mode. Here, the remote medical treatment system refers to a system storing, managing and analyzing health information of individuals and providing a health management service to individuals. When a chip mounted in the bio-sensor chip reader 800 is a bio-sensor chip for managing an individual's health, the bio-sensor chip reader 800 may be used to establish a u-health care system in association with the remote treatment system.

It can be well understood that the foregoing mobile communication terminal is not limited to a particular name. For example, the mobile communication terminal may be used by other names such as mobile phone, PDA, smartphone, or the like. The mobile communication terminal refers to a device performing functions such as a voice call, a message transmission, and the like, in a mobile communication network such as a CDMA, GSM, or the like, and accessing the Internet to perform a data transmission/reception function in a WLAN area.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A bio-sensor chip comprising:
unit cells connected to a plurality of word lines and a plurality of bit lines and including bio-sensors, respectively;
a word line control circuit selecting any one of the word lines; and
a bit line control circuit selecting any one of the bit lines, wherein the word line control circuit and the bit line control circuit are controlled by light.

2. The bio-sensor chip of claim 1, wherein the word line control circuit comprises a plurality of photo switches connected to the word lines, respectively.

3. The bio-sensor chip of claim 2, wherein the photo switches deliver a word line voltage to the word lines, respectively, when the light is irradiated thereto.

4. The bio-sensor chip of claim 3, wherein each of the photo switches comprises a photoresponse element controlled by light and a switching transistor controlled by the photoresponse element.

5. The bio-sensor chip of claim 1, wherein the bit line control circuit comprises a plurality of photo switches connected to the bit lines, respectively.

6. The bio-sensor chip of claim 5, wherein the photo switches deliver a bit line voltage to the bit lines, respectively, when the light is irradiated thereto.

7. The bio-sensor chip of claim 6, wherein each of the photo switches comprises a photoresponse element controlled by light.

8. The bio-sensor chip of claim 7, wherein each of the photo switches further comprises a switching transistor controlled by the photoresponse element.

9. The bio-sensor chip of claim 1, wherein the bio-sensor chips comprises an input terminal for receiving a word line voltage provided to the word lines.

10. The bio-sensor chip of claim 9, wherein the bio-sensor chips comprises an input terminal for receiving a bit line voltage provided to the bit lines.

11. The bio-sensor chip of claim 1, wherein the bio-sensor is an element for detecting a particular material by a biological acceptor through an interaction, a recognition reaction, an oxidation-reduction reaction, or a chemical reaction, and outputting a result of the detection as an electrical signal.

12. A bio-sensor chip reader for receiving a bio-sensor chip thereon, driving the bio-sensor chip, and analyzing an output from the bio-sensor chip, the bio-sensor chip reader comprising:
a word line light source unit outputting light for selecting a word line of the bio-sensor chip;
a bit line light source unit outputting light for selecting a bit line of the bio-sensor chip;
an analog-to-digital converter (ADC) converting an output signal from the bio-sensor chip into a digital signal; and
a controller controlling the word line light source unit and the bit light source unit to drive the bio-sensor chip, and analyzing the output from the bio-sensor chip provided through the ADC.

13. The bio-sensor chip reader of claim 12, wherein the bio-sensor chip comprises:
unit cells connected to a plurality of word lines and a plurality of bit lines and including bio-sensors, respectively;
a word line control circuit selecting any one of the word lines; and
a bit line control circuit selecting any one of the bit lines,
wherein one of the unit cells is selected by the word line control circuit controlled by the light output from the word line light source unit and the bit line control circuit controlled by the light output from the bit line light source unit.

14. The bio-sensor chip reader of claim 12, further comprising an output terminal for outputting a word line voltage to be provided to the word line.

15. The bio-sensor chip reader of claim 12, further comprising an output terminal for outputting a bit line voltage to be provided to the bit line.

16. The bio-sensor chip reader of claim 12, further comprising an input terminal for receiving an output signal from the bio-sensor chip.

17. The bio-sensor chip reader of claim 12, further comprising a cell light source unit for outputting light to be irradiated to the unit cells of the bio-sensor chip.
